(19) United States
(12) Patent Application Publication
(10) Pub. No.: US 2006/0026625 A1
(43) Pub. Date: Feb. 2, 2006

(54) SEARCH ENGINE FOR A VIDEO RECORDER

(76) Inventors: Haig H. Krakirian, Burbank, CA (US); Jim Bumgardner, Shadow Hills, CA (US)

Correspondence Address: DVA / PIONEER DIGITAL TECHNOLOGIES, SUITE 200, 2355 MAIN STREET, IRVINE, CA, 92614, US

(21) Appl. No.: 10/710,688

(22) Filed: Jul. 28, 2004

(51) Int. Cl. H04N 7/16; H04N 7/173

(52) U.S. Cl. 725/1; 725/100; 725/131

(57) ABSTRACT

The present invention is directed to a search engine for a video recorder. One embodiment of the present invention operates in an environment that includes one or more set-top boxes connected to or integrated within one or more output devices. The set-top boxes are used to transfer shows from a broadcast input source to one or more types of storage devices and to play back the shows from the storage devices to the output devices, either in a delayed-live fashion or at a later time of the user's choosing. The set-top box couples displays the display of a graphical user interface (GUI), which gives the user the ability to watch and/or record timeslot based programming, to order on-demand programming, and to playback previously recorded shows that reside on a local or remote storage device. A search engine is added to the GUI that lets the user receive results comprising all three types of programming with a single search.

### COPYRIGHT STATEMENT

All of the material in this patent document is subject to copyright protection under the copyright laws of the United States and of other countries. The owner of the copyright has no objection to the facsimile reproduction by anyone of the patent document or the patent disclosure, as it appears in the United States Patent and Trademark Office file or records, but otherwise reserves all copyrights whatsoever.

### BACKGROUND OF INVENTION

1. Field of the Invention

The present invention relates generally to search engines, and more particularly to a search engine for a video recorder system.

2. Background of the Invention

Video recorders are devices that are used in conjunction with a television set to enhance the user's entertainment experience. A user watches an output device, such as a television set, while the video recorder, which is either attached to or incorporated within the output device, is used for such things, for example, as tuning to particular stations, recording the shows, playing back previously recorded shows, and searching for shows to watch now or schedule for recording later.

In the past, a user searched for shows using a magazine such as “TV Guide”. The user would scan through the pages of the magazine until the appropriate show was located and then would manually tune their television to that channel. More recently, a program guide was provided with analog cable. Instead of a magazine, a specific channel was dedicated to the program guide and similar to a magazine, pages of the program guide were displayed on the screen and the user watched the pages on the screen to find a show that the user could then tune to or schedule to record.

As digital cable became more common, a more interactive program guide (IPG) was provided. While not only displaying pages similar to a magazine, the user was able to provide input and actively search for shows, rather than passively wait for the appropriate page to appear on the screen. For instance, the user could move forward in time to see shows in the future and the user could move between channels as well. IPGs also gave the user the ability to select shows automatically for tuning or recording by providing input to the IPG.

Magazine and IPG searches are “timeslot based” meaning one can find shows based on the show's timeslot. If the show airs at 9:00 AM every Sunday, then the show is found in the magazine under the 9:00 AM timeslot on Sunday and likewise in the IPG. More recently, a parallel type of programming has been offered to consumers, which is not timeslot based. This parallel type of programming is termed “on-demand” programming. On-demand programming is available to the user at any time without regard to a timeslot. Typically, newly released movies and sporting events are available on-demand for a fee and the user can order and watch the show at a time more convenient to the user. On-demand programming is typically ordered by navigating a different type of user interface that includes lists of shows that can be arranged by category, for instance, and by reading descriptions and/or watching short video clips that help the user choose a show to order.

As graphical user interfaces that allow the user to navigate an IPG as well as a list of on-demand programming has advanced, it has become difficult to present the user with a list of options in a unified way. For instance, a timeslot based IPG works well for timeslot based programs, but on-demand programs cannot be shown to the user in a manner that suggests that such on-demand programs are available in the timeslot the user is currently examining. Similarly, users are presented with lists of on-demand programs, but there is no way to also show the user that timeslot based programs are also available now. Thus, these two types of programs have developed in parallel and the user must search through two different types of interfaces to know all of the programming that is available at a certain time.

### SUMMARY OF INVENTION

The present invention is directed to a search engine for a video recorder. One embodiment of the present invention operates in an environment that includes one or more set-top boxes connected to or integrated within one or more output devices. The set-top boxes are used to transfer shows from a broadcast input source to one or more types of storage devices and to play back the shows from the storage devices to the output devices, either in a delayed-live fashion or at a later time of the user's choosing.

The set-top box couples displays the display of a graphical user interface (GUI), which gives the user the ability to watch and/or record timeslot based programming, to order on-demand programming, and to playback previously recorded shows that reside on a local or remote storage device. A search engine is added to the GUI that lets the user receive results comprising all three types of programming with a single search.

In one embodiment, the search engine utilizes a common key that is used as the basis for a search of three separate types of databases. The first type of database comprises data relating to timeslot based programming, the second type of database comprises data related to on-demand programming, the third type of database comprises data related to previously recorded shows that are available to the set-top box in use. The common key is used to query each database to find database entries that match the key.

Such keys are then used to output a list of results that match the search from all three databases.

In one embodiment, the search engine utilizes such factors, for instance, as title, category (e.g., horror or comedy), time, actors, etc. The present invention can be used in a “linking” model or an “acting on” model. In the linking model, results that are chosen that are “on demand” or “pay-per-view” (i.e., timeslot based) cause a link to be invoked that send the user to a separate application that allows the user to get more information and/or begin a process of ordering and paying for the show. In the “acting on” model a single application controls the entire process of searching, purchasing, and watching, without linking to a separate application.

### BRIEF DESCRIPTION OF DRAWINGS

The invention will be more fully understood by reference to the following drawings, which are for illustrative purposes only:

FIG. 1 is a functional block diagram of an embodiment of a set-top box.

FIG. 2 is a diagram of a configuration for one of the multiple tuners associated with the video recorder.

FIG. 3 shows a configuration for a single decoder.

FIG. 4 is a diagram of a typical tuner arrangement for use with a live TV signal.

FIG. 5 is a diagram of a typical tuner arrangement for use when recording transferring a signal to a storage device.

FIG. 6 shows an arrangement for when a user is watching a pre-recorded show that has completed recording already been transferred to a storage device.

FIG. 7 shows an arrangement for when a user is watching a pre-recorded show on the storage device while another show is being recorded transferred to the storage device.

FIG. 8 shows the structure of a search engine that is used in one embodiment of the present invention.

FIG. 9 shows the structure of a search engine that is used in one embodiment of the present invention.

FIG. 10 shows the structure of a search engine that is used in one embodiment of the present invention.

FIG. 11 is a flowchart showing the operation of a search engine that is used in one embodiment of the present invention.

FIG. 12 is a flowchart showing the operation of a search engine in a linking model according to one embodiment of the present invention.

FIG. 13 is a flowchart shoeing the operation of a search engine in an acting on model according to one embodiment of the present invention.

FIG. 14 is a functional block diagram of some of the components of one embodiment of the present invention.

FIG. 15 is a functional block diagram of some of the components of one embodiment of the present invention.

FIG. 16 is a functional block diagram of some of the components of one embodiment of the present invention.

### DETAILED DESCRIPTION

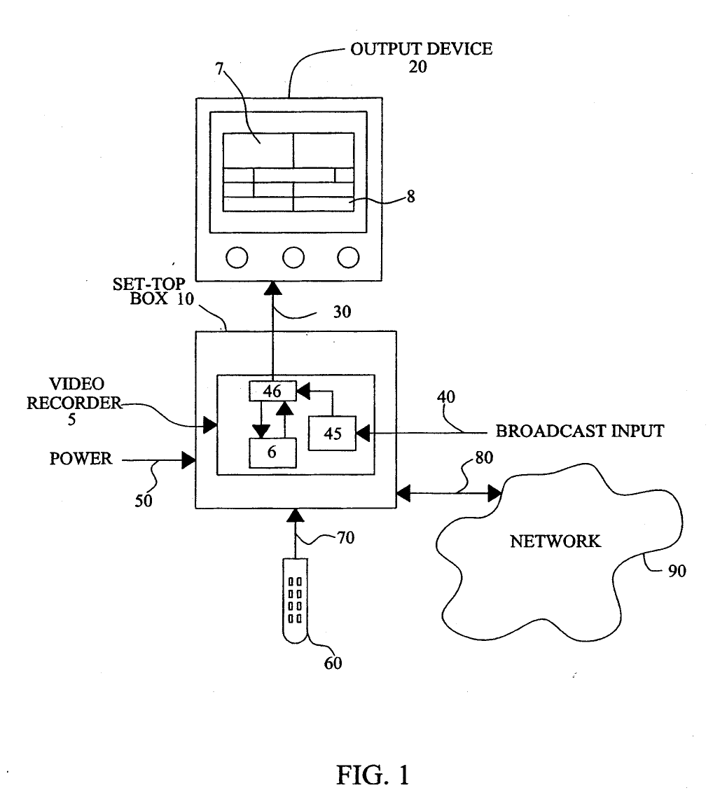

The present invention relates is directed to a search engine for a video recorder. A video recorder as used herein refers to a device capable of transferring broadcast signals and stored content to an output device, transferring broadcast signals to a storage device, and retrieving the broadcast signals from the storage device. The terms video recorder, personal video recorder (PVR), and digital video recorder (DVR) are used herein interchangeably. Referring more specifically to the drawings, for illustrative purposes an embodiment of a video recorder is shown in the functional block diagram of FIG. 1.

A video recorder 5 is an internal or external component of a set-top box 10. The video recorder 5 includes some or all of a combination of software, hardware, and firmware. In one embodiment, the video recorder 5 uses a storage device 6, such as a hard drive that is internal or external to the set-top box 10 where shows are saved. The set-top box 10 connects to an output device 20, which facilitates the use of broadcast signals, such as live television signals, video on demand broadcasts, downloads of Internet content, viewing of web pages, and viewing of content previously recorded transferred to the storage device 6. In the example of FIG. 1, set-top box 10 is shown as being external to output device 20. It should be understood by someone having ordinary skill in the art, that set-top box 10 may be internal to output device 20 as well.

A GUI 7 that includes an IPG 8 is provided, which is displayed on the output device 20. GUI 7 in conjunction with IPG 8 allows the user to control the video recorder 5, typically using a remote control 60. For instance, the user may search the IPG 8 and select shows which are then scheduled to be transferred to storage device 6. The software or firmware that controls set-top box 10 may be installed locally or it may be downloaded from the Internet as needed when configuring new set-top boxes or when updating existing ones.

Set-top box 10 is connected to output device 20 via a transmission line 30. Broadcast signals are received by the set-top box 10 via broadcast input source 40, which may be connected to either an antenna, cable television outlet, or other suitable input source. One or more tuner systems 45 are configured to allow the system to utilize broadcast signals from multiple channels. The video recorder component 5 be a component of includes a hard disk drive 6 or any other suitable memory device in conjunction with a volatile memory 46, such as a Random Access Memory (RAM). Typically, the broadcast input along line 40 is handled by the tuner 45. The signal is temporarily resident in memory 46 using a circular buffer or other cache before being transferred more or less permanently to storage device 6. The tuner system 45 works in conjunction with the buffering system 46 storage device 6 so that for each tuner in the system, each can simultaneously record transfer broadcast signals to the storage device 6, or display channels up to the given number of tuners on output device 20.

Set-top box 10 receives power through a line 50. Set-top box 10 receives user input entered from a handheld remote control 60 over a wireless link 70. Wireless link 70 may be an infrared (IR) link, a radio frequency (RF) link, or any other suitable type of link. A bi-directional data path 80 is provided to set-top box 10, through which set-top box 10 can access a network 90, either local, global, or both. Transmission line 40 may provide data from a variety of input sources including cable, satellite, or electromagnetic waves.

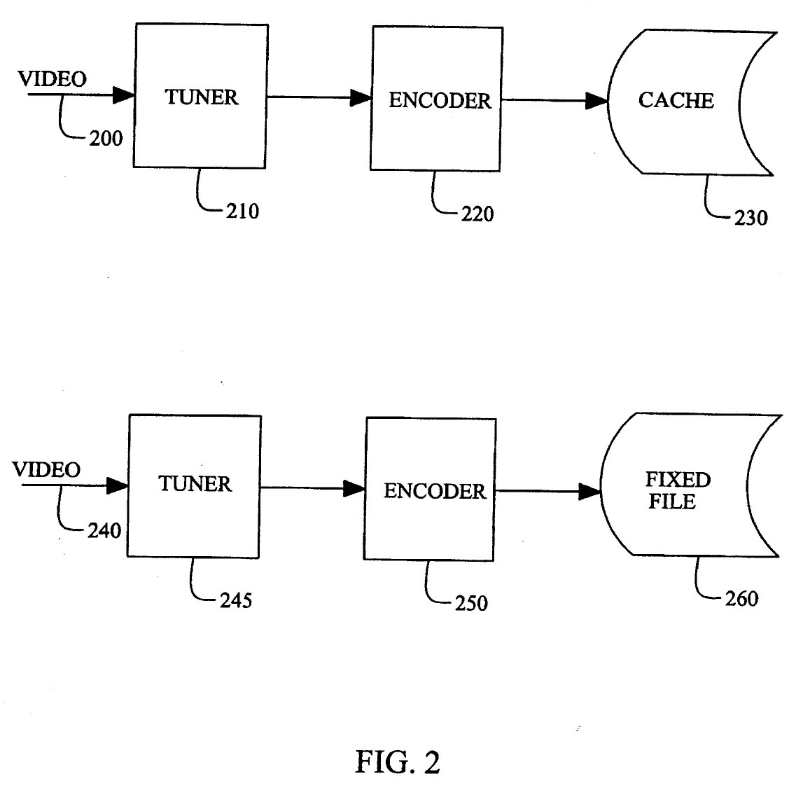

In one embodiment of the present invention, the PVR uses multiple tuners. Each of the tuners is normally associated with one encoder and one record cache, which may be a fixed or variable size record cache (for a live signal) or in the case of a recording a fixed file in the case where the incoming signal is merely transferred to the storage device. FIG. 2 shows various configurations for one of the multiple tuners associated with the PVR. Video stream 200 is provided to tuner 210, which passes the signal to encoder 220, which records transfers the data in a record cache 230. This configuration is used for analog use of a live TV signal.

An alternate configuration includes a video stream 240, which is then provided to tuner 245, which is then passed to encoder 250 and then to fixed recording file block 260. This configuration is useful for the analog recording transfer of a signal. For digital channels, encoder blocks 220 and 250 are removed, since the signal has already been digitized.

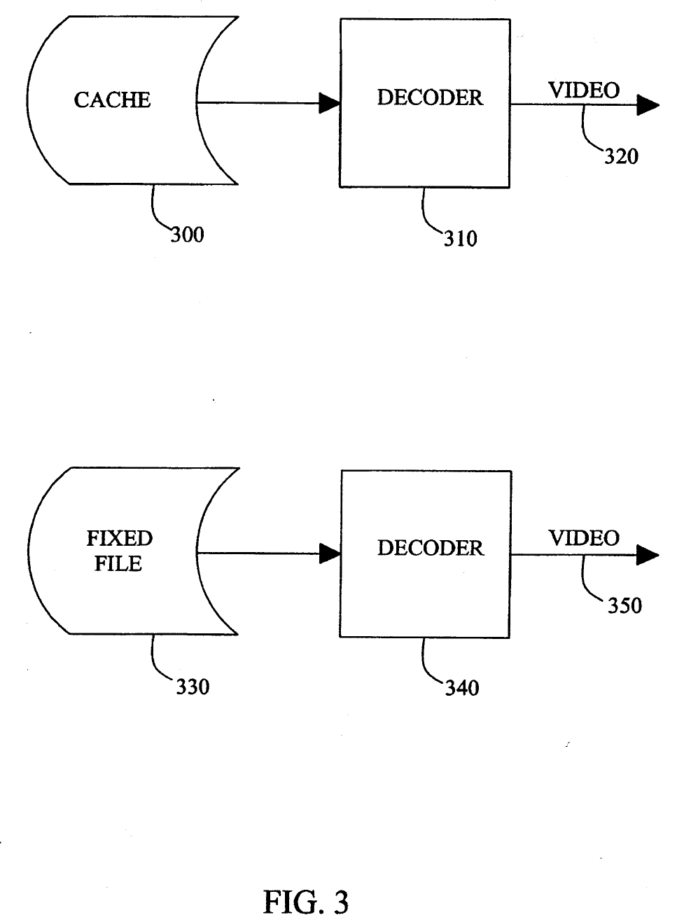

FIG. 3 shows a configuration for a single decoder. Cache 300 provides data to decoder 310, which outputs video signal 320. This arrangement is useful for watching live TV. Alternatively, fixed recording file block 330 provides data to decoder 340, which outputs a video signal 350. This embodiment is useful for playing back a pre-recorded show that has already been transferred to the storage device.

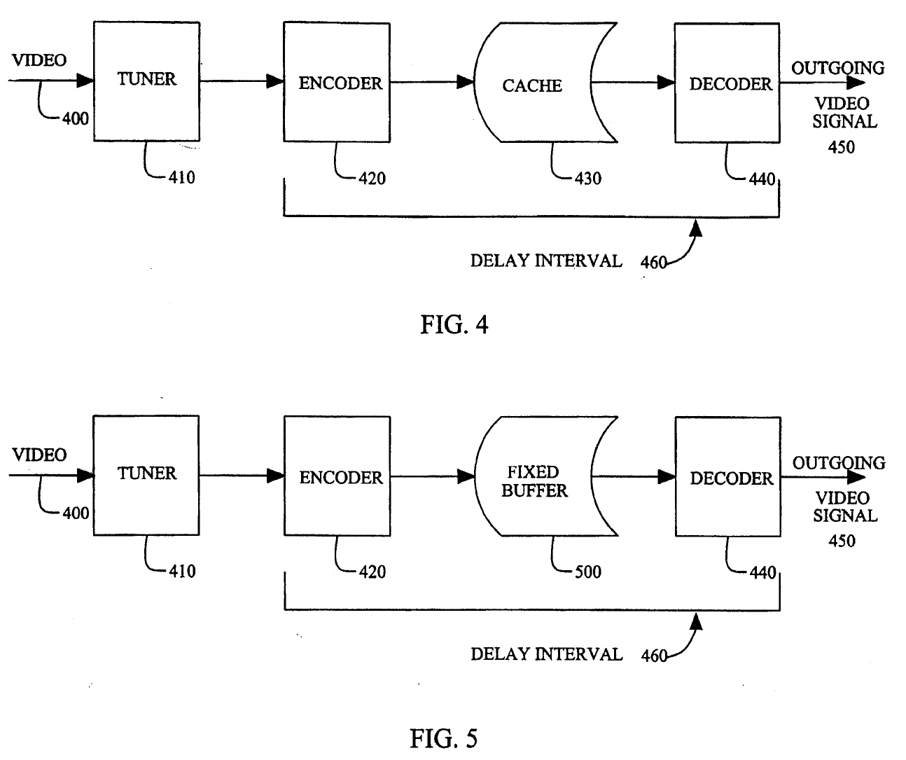

Each decoder shown in FIG. 3 is associated with a tuner/encoder pair. For a live TV signal, FIG. 4 shows an example of a typical arrangement, where video signal 400 is transmitted to tuner 410 then to encoder 420 and to record cache 430. After it leaves cache 430 it is decoded in block 440 and the outgoing video signal 450 is displayed on the television. It should be noted that a delay interval 460 of a given (x) number of seconds occurs between the time the signal reaches encoder 420 and is output by decoder 440. Therefore, a live TV signal is typically a signal that has been delayed by (x) seconds. If a user is watching a program and is currently recording transferring the program to a storage device as well, a record cache, as shown in block 430 of FIG. 4 is not used. Instead, a fixed recording buffer 500, shown in FIG. 5 is used.

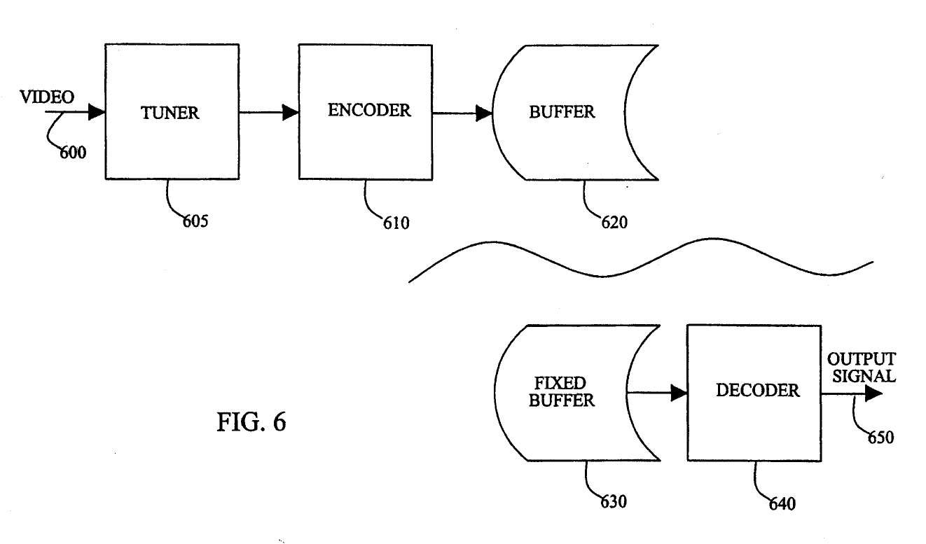

If the user is watching a pre-recorded show that has completed recording already been transferred to the storage device, the decoder is decoupled from the encoder (i.e., it reads from a different cache than the encoder), which continues to encode and cache the live video signal. This embodiment is shown in FIG. 6, where video signal 600 is tuned at block 605 and encoded at block 610 and stored in record buffer 620. Fixed recording medium buffer 630 is used to provide data to decoder 640, which provides the output signal 650.

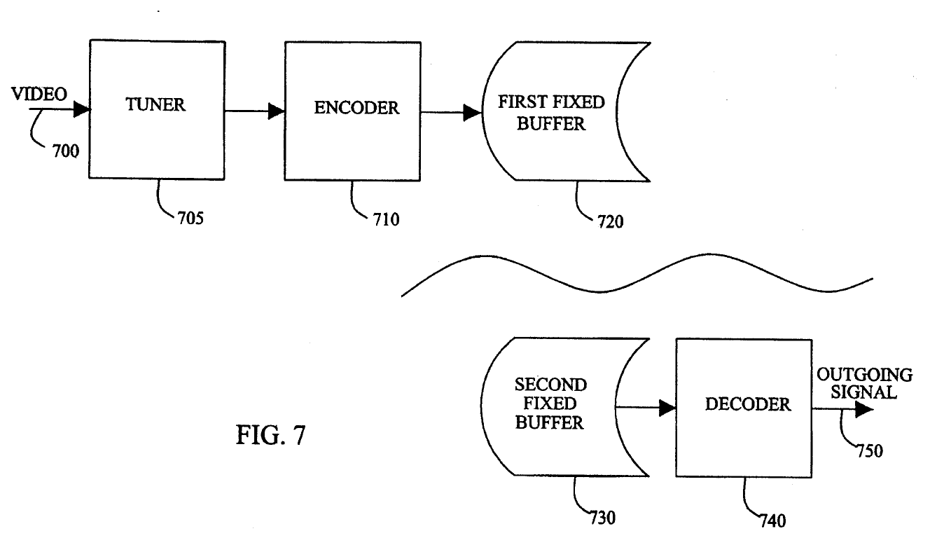

Finally, if a user is watching a pre-recorded show that resides already on the storage device while another show is currently being recorded transferred to the storage device, two different fixed buffers are implemented. This embodiment of the present invention is shown in FIG. 7. Video signal 700 is tuned at block 705 and encoded at block 710 and stored in a first fixed recording medium buffer 720. A second fixed recording medium buffer 730 is used to watch the previously recorded saved show, by transmitting and decoding the data at block 740 and displaying the output video signal 750 on a television.

According to one embodiment of the present invention, the set-top box couples displays the display of a graphical user interface (GUI), which gives the user the ability to watch and/or record timeslot based programming, to order on-demand programming, and to playback previously recorded shows that reside on a local or remote storage device. A search engine is added to the GUI that lets the user receive results comprising all three types of programming with a single search. The search engine is typically implemented as software resident on memory internal to the set-top box, such as a hard drive or Random Access Memory. But the search engine may also be implemented in part as firmware or hardware. The search engine code may also reside on a remote memory, either in another set-top box connected in a network, a shared hard drive, or as an Internet download.

In one embodiment, the search engine is integrated into three separate types of databases. The first type of database comprises data relating to timeslot based programming, the second type of database comprises data related to on-demand programming, the third type of database comprises data related to previously recorded shows that are available to the set-top box in use. Each type of database may be a single database or multiple databases of the same type. Moreover, if several separate databases of the same type are used, they may reside on a single storage location or they may be networked across multiple storage locations. For simplicity, each type of database is referred to as a “database”.

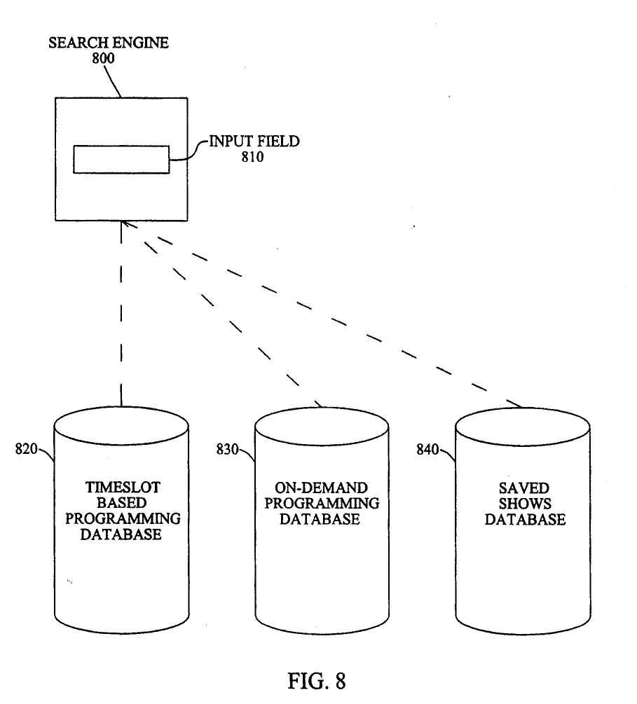

FIG. 8 shows the structure of a search engine that is used in one embodiment of the present invention. Search engine 800 includes input field 810 where the user inputs a search. Input field 810 is configured to operate in conjunction with timeslot based programming database 820, on-demand programming database 830, and saved shows database 840.

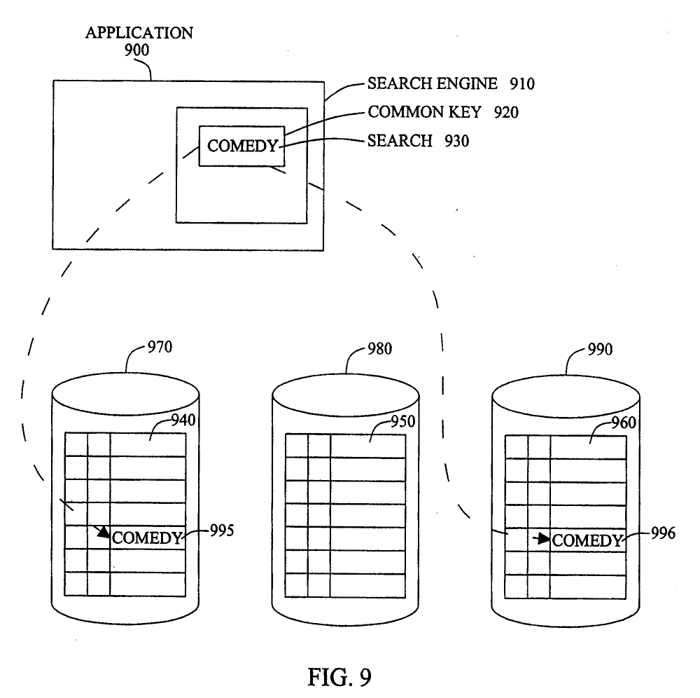

In another embodiment, the search engine utilizes a common key that is used as the basis for a search of each of the thee separate databases. The common key is used to query each database to find database entries that match the key. Such keys are then used to output a list of results that match the search from all three databases. FIG. 9 shows the structure of a search engine for a video recorder that uses a common key.

Search engine 910 is a component of application 900 includes common key field 920 where a search 930 is entered. Search 930 is used as data to search for entries in an appropriate field 940, 950, and 960 in databases 970, 980, and 990 that match common key field 920. Once the appropriate fields 940-960 are located in the databases, each row in the column relating to the appropriate fields 940-960 is searched to match an entry 995 and 996, for instance, with search 930. The search of FIG. 9 is achieved by any available programming language, for instance query based languages for databases.

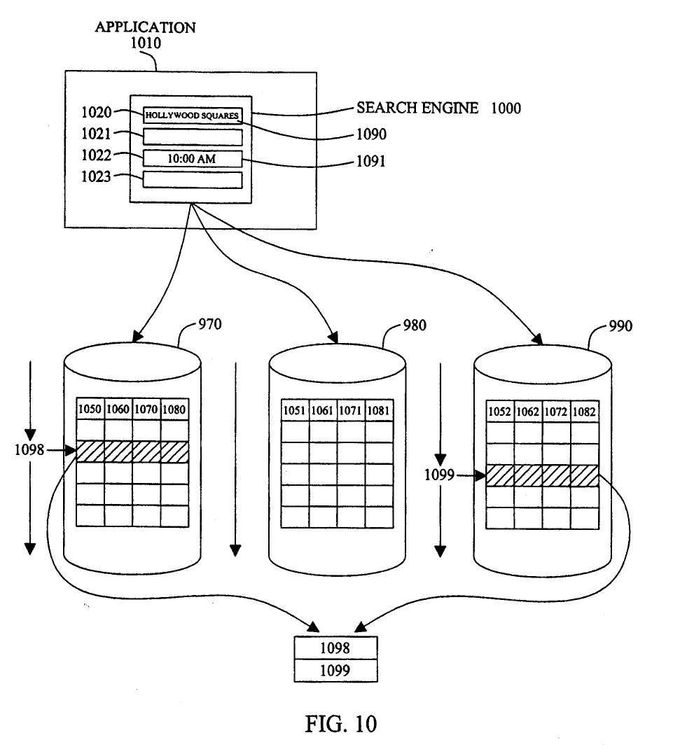

In one embodiment, the search engine utilizes such factors, for instance, as title, category (e.g., horror), time, actors, etc. In this embodiment, shown in FIG. 10, search engine 1000 is a component of application 1010 includes fields, such as title 1020, category 1021, time 1022, and actor or actress 1023 where a search is entered. Fields 1020-1023 are shown by purpose of example only, other fields are possible as well. The search is used as data to search for entries in appropriate fields in timeslot based database 1040, on-demand based database 1042, and saved shows database 1044.

Each database includes, at least fields for title 1050-1052, category 1060-1062, time 1070-1072, and actor or actress 1080-1082. Each database 1040, 1042, and 1044 may have other fields as well, which are not shown for the purpose of simplicity. Entries 1090 and 1091 are used to query databases 1040, 1042, and 144 in the appropriate database querying programming language. For instance, entries 1090 and 1091 might be “Hollywood Squares” and “10:00 AM”. In such a case, entries 1090 and 1091 are compared to the entries in each row of databases 1040, 1042, and 1044 along columns 1060-1062 and 1070-1072. Once entries matching the query in both rows 1098 and 1099 are obtained, the results 1095 can be output to the user for further selection.

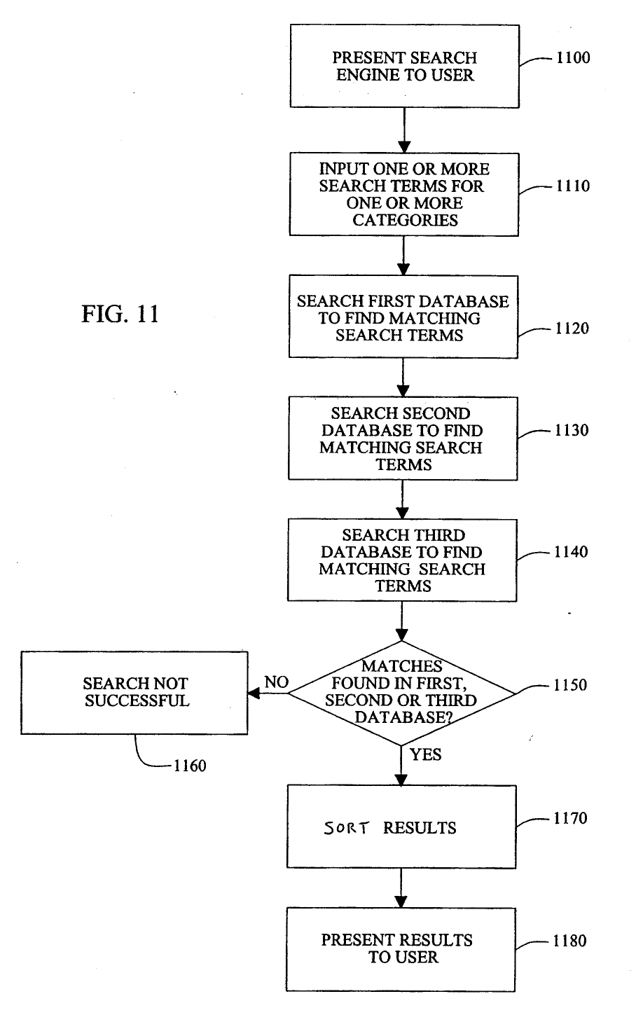

FIG. 11 is a flowchart showing the operation of a search engine according to an embodiment of the present invention. At block 1100, a search engine is presented to the user. At block 1110, the user inputs one or more search terms for one or more categories. At block 1120, the search term for each category is used to find a matching entry in a first database. At block 1130, the search term for each category is used to find a matching entry in a second database. At block 1140, the search term for each category is used to find a matching entry in a third database. At block 1150, it is determined if one or more matches were found in the first, second, or third databases. If not, the search was not successful and this is conveyed to the user at block 1160. Otherwise, the results are sorted at block 1170 and presented to the user at block 1180. The results can be presented to the user, for instance, buy providing a visual indication to the type of show found. On-demand programming may be indicated as such, while timeslot based and saved programming may receive different visual indicators.

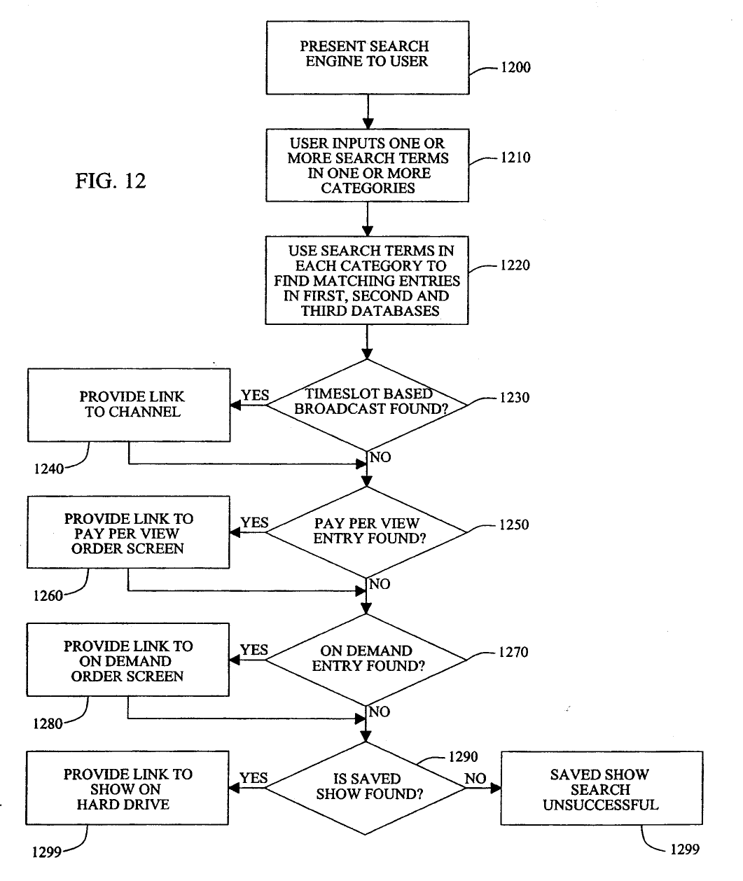

The present invention can be used in a “linking” model or an “acting on” model. In the linking model, results that are chosen that are “on demand” or “pay-per-view” (i.e., timeslot based) cause a link to be invoked that send the user to a separate application that allows the user to get more information and/or begin a process of ordering and paying for the show. FIG. 12 is a flowchart showing the steps involved in a search that uses the “linking ” model. At block 1200 a search engine is presented to the user. At block 1210, the user inputs one or more search terms in one or more categories. At block 1220, the search term for each category is used to find a matching entry in a first, second and third database.

At block 1230, it is determined if a timeslot based broadcast is found. If so, a link is provided that allows the user to tune to that broadcast at block 1240. After block 1240 or if no a timeslot based broadcast is found, it is determined if a timeslot based pay-per-view entry was found at block 1250. If so, the user is provided with a link to a page where the user can order the pay-per view program at block 1260. After block 1260 or if no timeslot based pay-per-view entry was found, then at block 1270, it is determined if an on-demand entry was found. If so, then at block 1280, a link is provided to a page where the user can purchase the on-demand programming. After block 1280 or if no on-demand entry was found, then at block 1290, it is determined if a show that has been saved on the local set-top box's hard drive or a connected hard drive is found. If so, a link is provided at block 1295 that allows the user to retrieve the saved show from the appropriate storage device. Otherwise the search was unsuccessful for saved shows at block 1299.

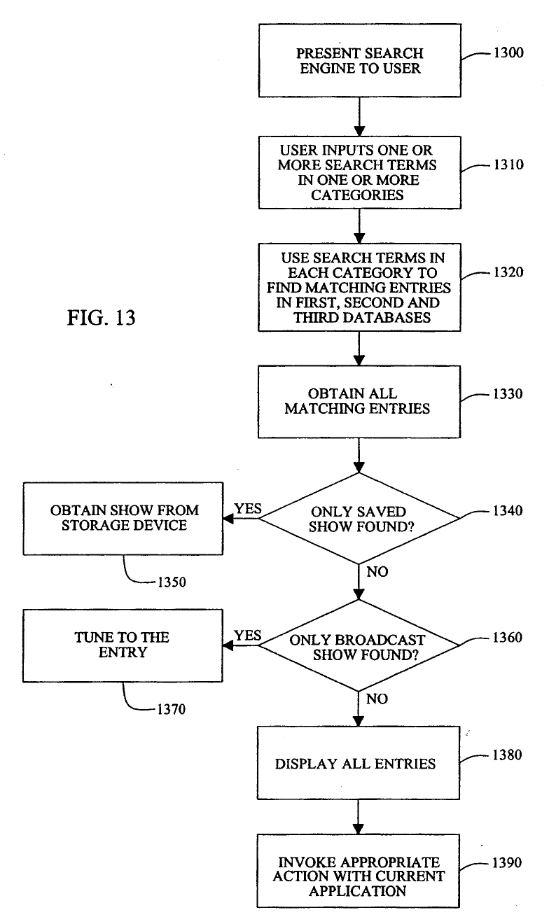

In the “acting on” model a single application controls the entire process of searching, purchasing, and watching, without linking to a separate application. The “acting on” model is illustrated in FIG. 13. At block 1300 a search engine is presented to the user. At block 1310, the user inputs one or more search terms in one or more categories. At block 1320, the search term for each category is used to find a matching entry in a first, second and third database. At block 1330, all of the matching entries are obtained. At block 1340, it is determined if only a saved show was found. If so, the saved show is obtained from a storage device at block 1350. Otherwise, at block 1360, it is determined, if only a broadcast entry was found. If so, the system tunes to that entry at block 1370. Otherwise all entries are displayed at block 1380 and the user chooses the appropriate action that is invoked by the current application at block 1390.

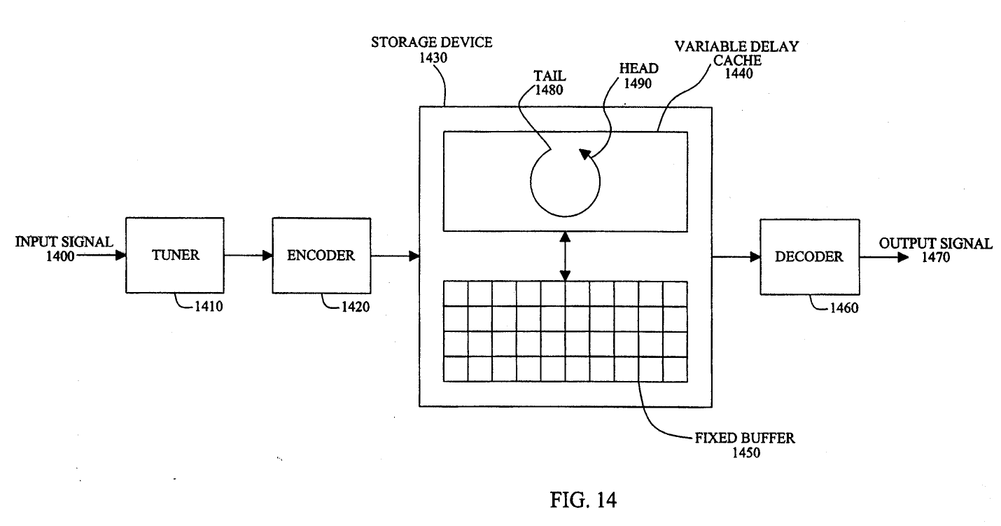

The operation of one embodiment of a set-top box is shown in FIG. 14. An input signal 1400 arrives at tuner 1410 and is encoded at block 1420. A storage device 1430 comprises a variable delay cache 1440 and a fixed buffer 1450. If the user is watching live television, the input signal 1400 is typically handled first in variable delay cache 1440. In this example, variable delay cache has a structure that is logically circular. The size of the cache controls the amount of delay. As signals are received in the cache 1440 they are added to the tail 1480 of the cache 1440.

As new signals are received, they eventually move to the head 1490 of the cache 1440. At that time, they are decoded at block 1460 and transferred as an output signal 1470 to an output device such as a television, for instance. The delay between the head 1490 and the tail 1480 is adjustable or can be completely eliminated to have a true “live television” experience. Variable delay cache 1440 is shown being a circular buffer, however, the actual locations in the storage device 1430 need not be contiguous or even reside on the same storage device. Instead, they can be in disparate locations on storage device 1430 and connected, for instance using pointers or other memory reference techniques, so that there is an ability to produce the data in a logical manner, but an actual contiguous space in storage device 1430 need not be reserved for the variable delay cache 1440. Moreover storage device 1430 can be used to represent the storage devices of multiple video recorder connected in a computer network arrangement.

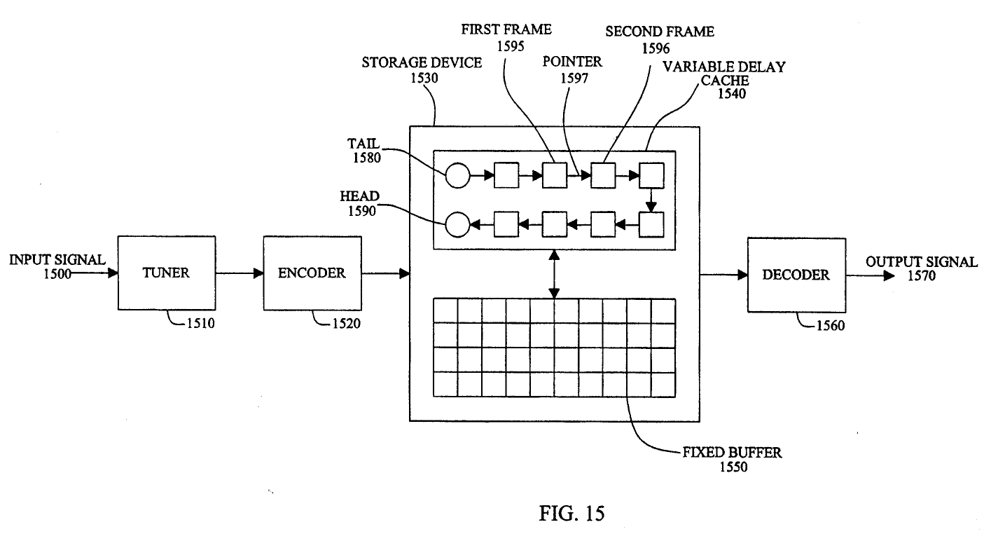

FIG. 15 shows the operation of a set-top according to another embodiment of the present invention. An input signal 1500 arrives at tuner 1510 and is encoded at block 1520. A storage device 1530 comprises a variable delay cache 1540 and a fixed buffer 1550. If the user is watching live television, the input signal 1500 is handled first in variable delay cache 1540. In this example, variable delay cache has a structure that is a linked list of files wherein each file represents one or more frames of the video that arrives along input signal 1500. The size of the linked list controls the amount of delay. As signals are received in the cache 1540 they are added to the tail 1580 of the cache 1540.

As new signals are received, they eventually move to the head 1590 of the cache 1540. At that time, they are decoded at block 1560 and transferred as an output signal 1570 to an output device such as a television, for instance. The delay between the head 1590 and the tail 1580 is adjustable or can be completely eliminated to have a true “live television” experience. Variable delay cache 1540 in linked list form connects each frame by a pointer structure, wherein a first frame 1595 and a second frame 1596 in storage device 1530 appear to be logically located near each other, or contiguous in storage device 1530, but actually first frame 1595 and second frame 1596 may be located far apart on storage device 1530 and are logically linked by pointer reference 1597.

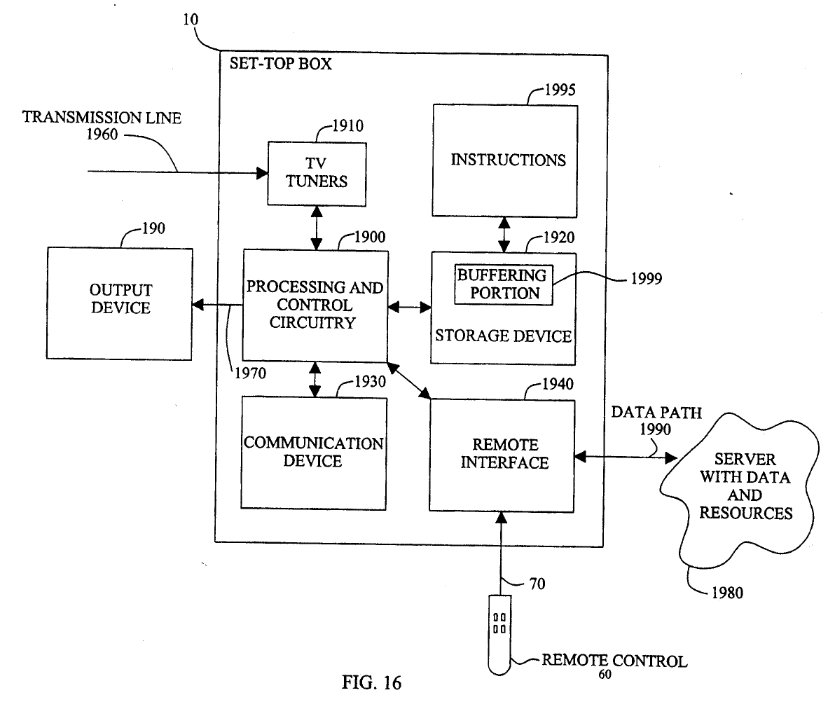

FIG. 16 is a functional block diagram that illustrates the components of an embodiment of the present invention. Note that FIG. 16 is intended to be a conceptual diagram and does not necessarily reflect the exact physical construction and interconnections of these components. Set-top box 10 includes processing and control circuitry 1900, which controls the overall operation of the system, the processing and control circuitry includes such components as processors, registers, buses, and other circuitry needed to operate a computing device. Coupled to the processing and control circuitry 1900 are one or more TV tuners 1910, a memory storage device 1920, a communication device 1930, and a remote interface 1940.

Tuners 1910 receive broadcast signals on transmission line 1960, which may originate from an antenna, a cable television outlet, a satellite connection, or another suitable broadcast input source. Processing and control circuitry 1900 provides audio and video output to device 190 via a line 1970. Remote interface 1940 receives signals from remote control 60 via wireless connection 70. Communication device 1930 is used to transfer data between set-top box 10 and one or more remote processing systems, such as a server 1980, via a data path 1990. Server 1980 includes, for instance, a web server, or other set-top boxes connected in a network arrangement, where data from the web or resources from connected set-top boxes are available via data path 1990.

Processing and control circuitry 1900 may include one or more of devices such as general-purpose microprocessors, digital signal processors, application specific integrated circuits, various types of signal conditioning circuitry, including analog-to-digital converters, digital-to-analog converters, input/output buffers, etc. Memory Storage device 1920 may include one or more physical memory devices, which may include volatile storage devices, non-volatile storage devices, or both. For example, memory storage device 1920 may include both random access memory (RAM), read-only memory (ROM), hard disk drives, various forms of programmable and/or erasable ROM, flash memory, or any combination of these devices.

Communication device 1930 may be a conventional telephone modem, an Integrated Services Digital Network adapter, a Digital Subscriber Line adapter, a cable television modem, or any other suitable data communication device. Instructions 1995 typically is resident in storage device 1920. Instructions 1995 control the overall functionality of the system, including the GUI, IPG, and the presentation of search engines. For instance, a search engine may be presented to a user and based on the search, instructions 1995 might tell set-top box 10 to use processing and control circuitry to search one or more databases in both storage device 1920 and along data path 1990. The results might, for instance, per instructions 1995, be retrieved, sorted, and presented to the user on output device 190 as links, or they could be invoked directly, for instance, to cause output device 190 to use tuners 1910 to tune to a specific channel.

Although the description above contains many specificities, these should not be construed as limiting the scope of the invention but as merely providing illustrations of some of the presently preferred embodiments of this invention. Thus the scope of this invention should be determined by the appended claims and their legal equivalents.

1. A method for searching for shows comprising:
providing a search engine application with one or more input fields;
matching said input fields to one or more common keys in a first, a second, and a third database, said first, second and third databases including at least one database of timeslot based entries, and at least one database of non-timeslot based entries; obtaining one or more results from said first, second, and third databases; and
presenting said results on an output device.

2. The method of claim 1 wherein said first database is a database having entries related to timeslot based programming.

3. The method of claim 1 wherein said second database is a database having entries related to on-demand programming.

4. The method of claim 1 wherein said third database is a database having entries related to saved shows.

5. The method of claim 1 wherein said step of presenting further comprises:
obtaining one or more of said results;
sorting said results; and
presenting said results as a list on said output device.

6. The method of claim 5 wherein said step of presenting said results as a list further comprises adding visual indicators to each of said results.

7. The method of claim 6 wherein said list comprises one or more links that are used to invoke external applications.

8. The method of claim 6 wherein said list comprises entries that are acted on by said search engine application.

9. The method of claim 1 wherein said input fields include a title, a time, an actor, or a category.

10. The method of claim 1 wherein said method for searching for shows takes place using a personal video recorder.

11. A system for searching for shows comprising:
a search engine application with one or more input fields;
a first, a second, and a third database with one or more common keys for matching said input fields to said common keys;
one or more results obtained from said first, second, and third databases; and
a list of said results.

12. The system of claim 11 wherein said first database is a database having entries related to timeslot based programming.

13. The system of claim 11 wherein said second database is a database having entries related to on-demand programming.

14. The system of claim 11 wherein said third database is a database having entries related to saved shows.

15. The system of claim 11 further comprising an application for sorting said results.

16. The system of claim 15 wherein said list further comprises one or more visual indicators that may be added to each of said results.

17. The system of claim 16 wherein said list comprises one or more links that are used to invoke external applications.

18. The system of claim 16 wherein said list comprises entries that are acted on by said search engine application.

19. The system of claim 11 wherein said input fields include a title, a time, an actor, or a category.

20. The system of claim 11 wherein said shows are searched for using a personal video recorder.

21. A computer program product comprising:
a computer usable medium having computer readable program code embodied therein configured to cause a computer to for search for shows comprising:
computer readable program code configured to cause a computer to provide a search engine application with one or more input fields;
computer readable program code configured to cause a computer to match said input fields to one or more common keys in a first, a second, and a third database, said first, second and third databases including at least one database of timeslot based entries, and at least one database of non-timeslot based entries;
computer readable program code configured to cause a computer to obtain one or more results from said first, second, and third databases; and
computer readable program code configured to cause a computer to present said results on an output device.

22. The computer program product of claim 21 wherein said first database is a database having entries related to timeslot based programming.

23. The computer program product of claim 21 wherein said second database is a database having entries related to on-demand programming.

24. The computer program product of claim 21 wherein said third database is a database having entries related to saved shows.

25. The computer program product of claim 21 wherein said computer readable program code configured to cause a computer to further comprises:
computer readable program code configured to cause a computer to obtain one or more of said results;
computer readable program code configured to cause a computer to sort said results; and
computer readable program code configured to cause a computer to present said results as a list on said output device.

26. The computer program product of claim 25 wherein said computer readable program code configured to cause a computer to present said results as a list further comprises adding visual indicators to each of said results.

27. The computer program product of claim 26 wherein said list comprises one or more links that are used to invoke external applications.

28. The computer program product of claim 26 wherein said list comprises entries that are acted on by said search engine application.

29. The computer program product of claim 21 wherein said input fields include a title, a time, an actor, or a category.

30. The computer program product of claim 21 wherein said shows are searched for using a personal video recorder.
